(19) United States
(12) Patent Application Publication
(10) Pub. No.: US 2008/0206540 A1
(43) Pub. Date: Aug. 28, 2008

(54) Mechanically Reinforcing Complex Which is Intended to be Incorporated into a Composite Part and Method of Producing One Such Part

(75) Inventors: Philippe Sanial, Vernoux En Vivarais (FR); Michel Serillon, Mariac (FR)

Correspondence Address: CANTOR COLBURN, LLP, 20 Church Street, 22nd Floor, Hartford, CT, 06103, US

(73) Assignee: CHOMARAT COMPOSITES, Paris (FR)

(21) Appl. No.: 12/088,806

(22) PCT Filed: Sep. 28, 2006
(86) PCT No.: PCT/FR2006/050958

§ 371 Date: Mar. 31, 2008

(30) Foreign Application Priority Data
Sep. 29, 2005 (FR) 0552960

(51) Int. Cl. B32B 7/08; B29C 45/00

(52) U.S. Cl. 428/223; 264/45.3

(57) ABSTRACT

Mechanically reinforcing complex (3), intended for incorporation in a composite part (1) with injected resin based core (2), comprising a reinforcing textile structure (5), for impregnation in a thermoset resin conferring mechanical properties.

It is characterized in that it comprises a layer of open-cell foam (4), present on the inner face of the complex (3), intended to come into contact with the resin of the injected core (2).

### TECHNICAL FIELD

The invention relates to the field of technical textiles, and more particularly textiles for use as reinforcements for the fabrication of composite parts. It relates more particularly to a mechanically reinforcing complex used in the context of methods for producing thick parts, comprising a core based on injected resin.

The invention relates more specifically to the particular constitution of such a complex, which serves to improve the mechanical properties of the composite part, and particularly in terms of resistance to delamination, thanks to an equally original method.

### PRIOR ART

In general, composite parts are used in many applications. They are appreciated for their properties of mechanical strength combined with very low density. By way of example, mention can be made of the preparation of various panels used in the field of the construction of maritime or automotive vehicles, for example for producing parts of ships' hulls, or even walls of end gates of truck trailers.

Such parts therefore frequently include the combination of a core having a relatively high thickness, on which a reinforcing textile structure is placed, generally impregnated with a thermoset resin conferring mechanical properties (mechanizing). In practice, the construction of such a part initially requires the preparation of the core. This core is frequently prepared on the basis of a polyurethane resin, appreciated for its mechanical properties, combined with relatively low density, about 30 to 70 kg/m³. This core is then sanded to its final shape, and then covered on its outer face with a reinforcing textile structure, typically based on high toughness fibres, such as glass, carbon or aramid.

This textile reinforcing structure is then impregnated with a mechanizing resin, such as in particular resins of unsaturated polyesters commonly called “UP” for “unsaturated polyester”, or epoxy resins. After curing, this resin, which deeply impregnates the textile structure, thereby confers additional stiffness to the composite part. It is understandable that the sequence of the various steps demands delicate handling operations, so that it is advisable to eliminate the operation of bonding the reinforcement to the core.

One commonly employed solution is to carry out the injection of the polyurethane foam forming the core, in a mould whereof one of the sides has previously received the reinforcing textile structure. However, a problem arises during the injection of the polyurethane resin, because the said resin, which is injected under pressure, tends to penetrate into the reinforcing textile structure. Hence, the said structure can no longer be impregnated by the thermoset mechanizing resin, and therefore to the detriment of the mechanical properties of the composite part.

To solve this problem, the Applicant proposed in document EP 1 365 055, the use of reinforcing structures comprising an elastomer layer, combined with a textile structure. This elastomer layer performs a barrier function, and prevents the polyurethane foam from penetrating into the textile reinforcing structure, which thereby preserves its capacity to be impregnated by the thermoset mechanizing resin. However, this solution has a number of drawbacks in terms of mechanical strength. This is because the presence of a sealed barrier layer constitutes a mechanical discontinuity, which therefore forms an area of embrittlement in which the risks of delamination may be high.

Another solution has also been proposed to avoid the operations of sanding of a prefabricated core. Thus, document FR-2 149 427 describes a method consisting in the use of a complex combining a textile reinforcement with a foam layer impregnated with a mechanizing resin. This complex is placed in the mould, with the foam layer forming a reservoir of mechanizing resin guided towards the interior of the future core. After injection of the components reacting to produce the resin of the core, the expansion of the said resin causes a crushing of the impregnated foam layer. This compression of the foam expels the mechanizing resin which impregnated the foam, and in consequence, impregnates the textile reinforcement in contact with the mould walls. This method, although having the advantage of limiting the number of operations and handlings, nevertheless has serious drawbacks in terms of stiffness of the final part. In fact, when they are placed in the mould, the textile reinforcement and the resin impregnated foam layer are independent, and, after migration of the resin, their interface zones remain an area where the risks of delamination are high. The same applies to the interface zone between the core resin and the foam layer impregnated with the mechanizing resin.

The same problems are observed with the method described in document U.S. Pat. No. 5,112,663, in which the foam loaded with mechanizing resin is dried by the pressure applied during the closure of the mould, between the lid of the mould and the prefabricated core. It may also be observed that these mechanisms of resin migration and diffusion by mechanical depression do not serve to guarantee perfect uniformity of the resin concentration over the whole surface of the composite part.

It is one object of the invention to permit the production of reinforced composite parts while limiting the handling steps.

It is a further object of the invention to improve the delamination resistance of composite parts incorporating reinforcing textile structures, and intended to be impregnated with a mechanizing resin.

### SUMMARY OF THE INVENTION

The invention therefore relates to a mechanically reinforcing complex. Such a complex is intended to be incorporated in a composite part based on injected resin. This complex comprises, in a manner known per se, a reinforcing textile structure, which is intended to be impregnated with a thermoset mechanizing resin, for example based on unsaturated polyester or epoxy resin.

According to the invention, this reinforcing complex is characterized in that it comprises a layer of open cell foam, present on the inner face of the complex, that is the face intended to come into contact with the injected foam.

In other words, the reinforcing complex includes a foam layer which has a certain permeability to the injected foam, which constitutes the core of the composite part. Thanks to this controlled permeability, the reinforcing complex is intimately combined with the core during the fabrication thereof. In fact, the injected foam of the core penetrates into the foam layer during the injection, thereby anchoring it, and hence anchoring the reinforcing complex, with regard to the core. In other words, during its formation, the core partially penetrates into the reinforcing complex, and more precisely, of the characteristic foam layer.

This characteristic foam is selected to have an optimized porosity with regard to the resin of the core. This porosity is in fact selected to ensure limited penetration of this injection resin, in order to prevent the said resin from impregnating the textile structure that is intended to subsequently receive the mechanizing resin. The degree of penetration of the core resin into the foam layer can be determined as a function of the thickness of the said foam layer, and of the chemical nature of the various components used to form this injection resin. In particular, the viscosity of each of the components used to prepare this resin is taken into account, with the understanding that the viscosity of these components is relatively reduced at the start of the reaction that leads to the formation of the core, but that this viscosity increases relatively rapidly as soon as the reaction between these various components is initiated. The limited permeability of the foam layer is therefore predominant in the first moments of the injection reaction of the foam intended to form the core.

Depending on the desired applications, the reinforcing textile structure of the complex may be prepared in various ways.

This textile structure may be prepared in particular in the form of a fibrous layer, based on fibres of glass, carbon or aramid, separate or combined. These fibres may be organized in the form of a plain or multidirectional fabric, or in the form of a mat having virtually isotropic properties.

The reinforcing textile structure may also consist of an assembly of a plurality of fibrous layers, combined to optimize the impregnation of the thermoset mechanizing resin. It may, for example, be a textile structure such as sold under the Rovicore brand by the Applicant.

The characteristic foam layer can be joined with the reinforcing textile structure in various ways. Thus, and preferably, the textile structure and the foam layer can be joined by stitching/knitting, that is by a mechanical joining thanks to the binding threads which pass through the foam layer and the textile structure. This type of joining serves in particular to ensure good cohesion between the two components of the complex, and very severely limits the risks of delamination.

However, the foam layer and the textile structure can be joined in other ways. Mention can be made in particular of joining by needling, whereby certain fibres of the reinforcing fibrous structure are displaced to penetrate into the characteristic foam layer. These two layers can also be joined by bonding, while nevertheless ensuring that this bonding is not sealed, in order to prevent the creation of a zone of sudden changes in mechanical properties, a source of embrittlement. This bonding can therefore be obtained in a non-uniform manner by the presence of an openwork adhesive film, or even by the distribution of bonding points. These bonding points must be sufficiently close to firmly join the reinforcing textile structure with the foam layer, but they must not be too close, in order to facilitate the flow of the various resins, and to prevent the creation of accumulation zones.

In practice, the characteristic foam layer is selected for its properties of compatibility with the injection resin. Thus, in the preferable case of the injection of a polyurethane based core, the foam and its properties are also selected from the same material.

Advantageously, in certain circumstances, it is possible to incorporate in the complex, a film inserted between the foam layer and the reinforcing layer. Such a film thereby ensures a certain seal between the open cell foam and the textile reinforcement in the case in which the penetration of the core is excessive, and in particular close to the injection points. The possibility of the foam of the core being mixed with the reinforcing mechanizing resin is therefore avoided. This film is advantageously made from a material that is degraded or dissolved during the injection reactions of the mechanizing resin. A material can be selected in particular that is degraded by the styrene frequently present in the mechanizing resins. It is in fact preferable for the film to disintegrate, to at least partially disappear, and no longer remain in the state of a film in the final part, to avoid causing the appearance of embrittlement zones detrimental to the solidity of the composite part. This disintegration is facilitated by the fact that the film is perforated by the stitching thread binding the layers of the complex. This disintegration can be further improved in the case in which the film has specific preperforations, being added to the perforations made by the stitching threads.

In practice, the complex according to the invention can be used by an advantageous method, because it serves to do away with the operations of sanding of a prefabricated core.

Thus, such a method comprises the following steps:
placement in a mould of a complex comprising the textile reinforcing structure combined with an open cell foam layer;
injection into the mould of the components reacting to produce a resin forming the core and coming into contact with the open cell foam layer;
impregnation of the textile reinforcing structure by injecting a mechanizing resin.

In other words, contrary to the prior art methods in which the core is prefabricated, and then sanded to have a surface texture permitting the bonding of the reinforcement, the method according to the invention produces the bonding of the reinforcement directly during the injection of the core resin. It is by the partial penetration of this core resin into the open cell foam layer that the anchoring of the reinforcement takes place, because the latter is mechanically joined to this open cell foam layer.

In practice, the injection of the mechanizing resin into this textile reinforcement can take place in the same mould, directly after injecting the components forming the foam of the core.

It is also possible to carry out this injection of mechanizing resin in a different mould from the one in which the core has been formed. Thus, in this configuration, the steps of preparation of the core with bonding of the reinforcement is separated from the step of injecting and curing the mechanizing resin in the reinforcement. In the case in which these two operations take place in different operating conditions in terms of time and temperature, it is thereby possible to optimize the fabrication process.

In certain cases, it is also possible, between the formation of the core and the injection of the mechanizing resin, to open tie mould to place supplementary layers above the reinforcing layer. Such supplementary layers may be appearance layers, such as layers of Gelcoat type polyester resin, additional reinforcing layers, or plastic or metal inserts.

The composite parts made in the method can easily be identified, insofar as the core resin partially penetrates into the open cell foam layer of the mechanically reinforcing complex.

In practice, the invention therefore serves to produce parts whereof the reinforcing complex is joined to the core directly during the core injection operation. In certain cases, the reinforcing complex may also be arranged in the form of a preshaped cutout, or in the form of a cutout stitched to form a bag into which the core foam is injected, with maintenance of the shape inside the mould as required.

### BRIEF DESCRIPTION OF THE FIGURES

The manner in which the invention is implemented, and the advantages thereof, will clearly appear from the description of the embodiments that follow, in conjunction with the appended figures in which:

FIG. 1 is a brief perspective view of a composite part incorporating the complex according to the invention, shown in a partially cutaway view;

FIG. 2 shows a cross section of the part of FIG. 1;

FIG. 3 shows a cross section of a complex prepared according to an exemplary embodiment;

FIGS. 4 to 8 show cross sections of the mould in which the steps of the inventive method are implemented.

### MANNER FOR IMPLEMENTING THE INVENTION

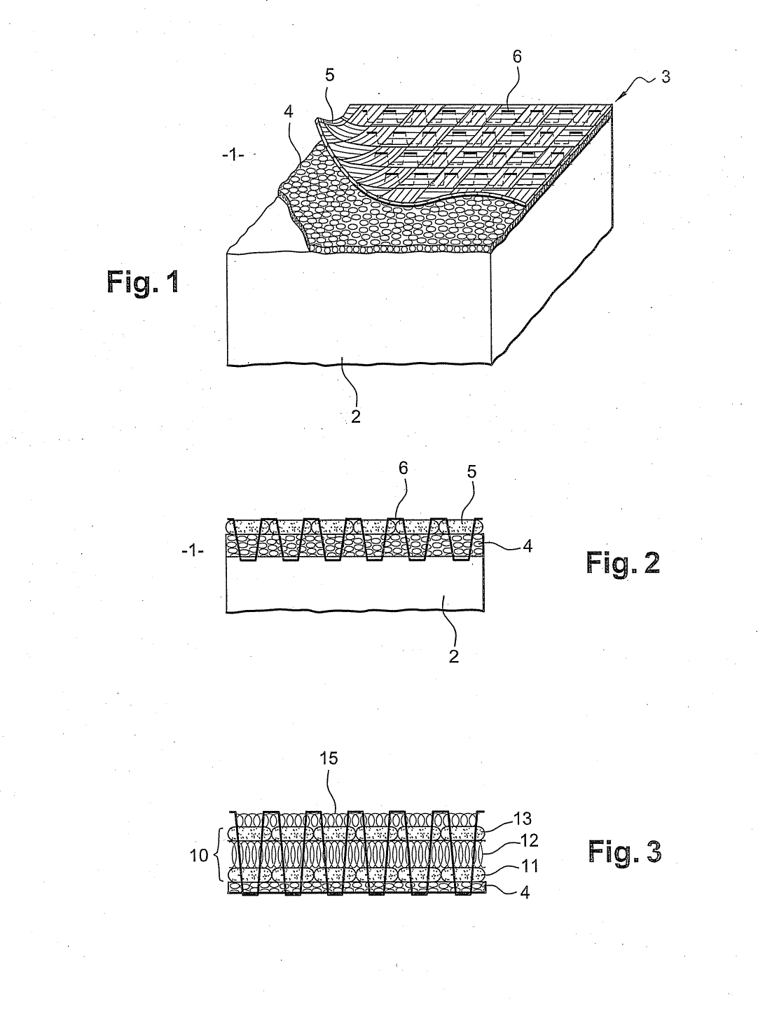

FIG. 1 shows a composite part (1), including a core (2) associated with the reinforcing complex (3).

According to the invention, this reinforcing complex (3) comprises an open cell foam layer (4), combined with a reinforcing textile structure (5). The foam layer (4) and the reinforcing textile structure (5) are joined by stitching/knitting using binding threads (6).

Although it is not limited to this type of particular application, the invention has an advantage during the production of composite parts including a core (2) prepared by the injection of components reacting to form a polyurethane foam. In this case, the foam forming the characteristic layer (4) coming into contact with this core (2) is also preferably based on polyurethane.

The thickness of the foam layer (4) may be variable, and determined according to the material used to form the core (2), particularly their viscosity. This thickness may typically range from 1 to 10 mm. Similarly, the density of the foam (4) may be variable, conditioning the rate of penetration of the core injection resin. This density may typically be between 20 and 250 g/l. In practice, the size and shape of the cells employed may be adapted to the method and to the matrix used.

By way of example, the complex (3) shown in FIGS. 1 and 2 may comprise a polyurethane foam layer having a density of 30 kg/m³, and a thickness of 3 mm, and hence an area density of 90 g/m².

The complex of the invention also comprises a reinforcing layer (5) which, in the example shown in FIGS. 1 and 2, is a two-directional fabric based on high toughness yarns and typically glass yams. Many alternative embodiments can be provided in terms of this reinforcing layer (5) particularly by using unidirectional reinforcements, or even glass fibre mats.

By way of example, the foam layer mentioned previously may be combined with a glass fibre mat, using fibres having an average length of 50 mm to form a mat having a mass of 300 g/m². This mat may be joined by stitching/knitting using synthetic yarns in particular.

In the embodiment shown in FIG. 3, the reinforcing textile structure (10) may consist of the assembly of a plurality of layers. Thus, two actual reinforcing layers (11,13) may be separated by an intermediate layer (12) prepared based on synthetic yarns having a degree of curl, and therefore allowing the flow of the thermoset mechanizing resin. The reinforcing layer (13) may receive a voile (15) on its outer face. This voile serves to provide an overall more uniform surface texture, and to mask the corrugations due to the reinforcing texture (13). This appearance voile (15) may be joined to the complex by stitching, as shown in FIG. 3. It may also be joined in various ways, and for example by bonding or needling.

In an embodiment not shown, the complex according to the invention may comprise a film inserted between the open cell foam layer and the textile reinforcement. Such a film serves to prevent excessive migration of the core foam through the open cell foam, a migration that would penetrate the textile reinforcing layer. Such a film may be of various types, insofar as it has a certain chemical compatibility with the various materials of the resins that it is liable to contact. Good results have been obtained by using polyurethane films, typically a few tens of microns thick. This film is sandwiched between the various elements of the complex, and held with respect to said elements by the stitching thread passing through it. The fineness of the stitching holes and the presence of the stitching thread do not excessively affect the tightness of this film, and facilitates its disintegration by the components of the mechanizing resin.

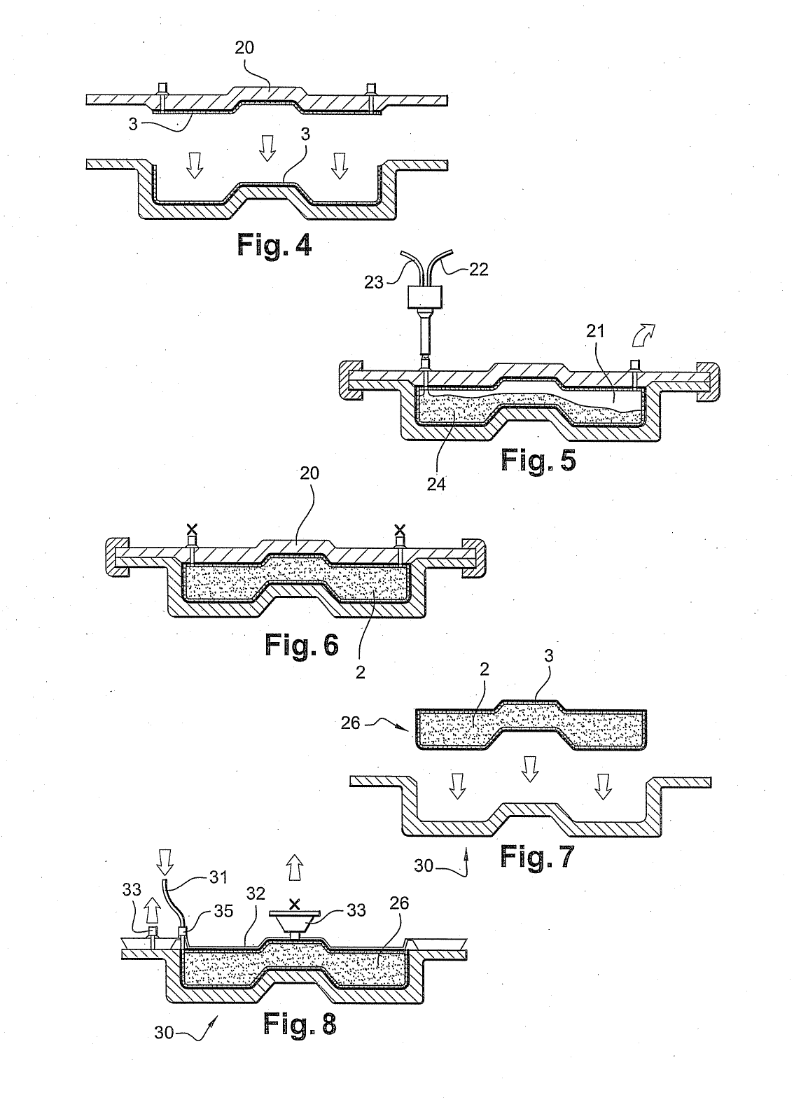

The reinforcement according to the invention can be used by the method described in FIGS. 4 to 8.

Thus, in a first step, the complex (3) according to the invention is placed in a mould (20), to line the walls thereof. The placement may, for example, be carried out using a layer of adhesive materials sprayed on the walls of the mould (20). After lining the mould (20), the mould is closed to confine a closed space (21) into which, as shown in FIG. 5, the chemical components (22, 23) are injected of the polyol and isocyanate type which, reacting with one another, formed the polyurethane foam (24) constituting the core material of the future part. During this reaction, an expansion takes place, completely filling the internal space (21), as shown in FIG. 6. When it comes into contact with the open cell foam layer (4) of the reinforcing complex (3), the polyurethane foam of the core (2) partially penetrates into this layer, and thereby effectively anchors the complex to the core.

Subsequently, it is possible to carry out a second injection step, for the penetration of the mechanizing resin into the mould (20) to impregnate the textile reinforcement (5) of the characteristic complex.

However, in the alternative shown in FIG. 7, the core (2) combined with the complex (3) can be extracted from the mould. This combination (26) is easily handled insofar as the reinforcement (5) is firmly anchored to the core (2) thanks to its open cell foam layer (4). This combination can thereby, as shown in FIG. 8, be placed in a mould (30) dedicated to the injection of the mechanizing resin, typically based on polyester, which is injected according to specific operating conditions. Thus, the mould for this injection may comprise a lid (32) formed of a flexible membrane, allowing the application of a downward pressure or depression (33) causing the resin to defuse from a smaller number of injection points.

The opening of the mould (20) and the subsequent transfer of the part (26) that it contains to another mould, serves to partially relieve the mechanical stresses imposed on the reinforcing textile (5), and in particular to facilitate the subsequent diffusion of the mechanizing resin. Depending on the applications, it is also possible to deposit additional layers, in particular of “Gelcoat” on the textile reinforcement (5), before injection of the mechanizing resin (31).

It appears from the above that the complex according to the invention has many advantages, and particularly the advantage of allowing the production of reinforced injected parts in a single step before impregnation of the reinforcement, while preserving excellent properties of resistance to delamination by punching.

1. Mechanically reinforcing complex (3), intended for incorporation in a composite part (1) with injected resin based core (2), comprising a reinforcing textile structure (5), for impregnation in a thermoset resin conferring mechanical properties, characterized in that it comprises a layer of open-cell foam (4), present on the inner face of the complex (3), intended to come into contact with the resin of the injected core (2).

2. Reinforcing complex according to claim 1, characterized in that the reinforcing textile structure is a fibrous layer (5).

3. Reinforcing complex according to claim 1, characterized in that the reinforcing textile structure (10) is an assembly of a plurality of fibrous layers (11-13).

4. Reinforcing complex according to either of claims 2 and 3, characterized in that the fibrous layer (5) is based on glass, carbon or aramid fibres, separate or combined.

5. Reinforcing complex according to claim 1, characterized in that the foam layer (4) and the reinforcing textile structure (5) are joined by stitching/knitting.

6. Reinforcing complex according to claim 1, characterized in that the foam layer and the reinforcing textile structure are joined by needling.

7. Reinforcing complex according to claim 1, characterized in that the foam layer and the reinforcing textile structure are joined by non-uniform bonding.

8. Reinforcing complex according to claim 1, characterized in that the foam layer is based on polyurethane.

9. Reinforcing complex according to claim 1, characterized in that it comprises a film inserted between the open cell foam layer and the reinforcing textile structure layer.

10. Method for fabricating a composite part, including an injected resin based core combined with a reinforcing structure impregnated with a thermoset resin conferring mechanical properties (mechanizing), characterized in that it comprises the following steps:
placement in a mould (20) of a complex (3) comprising the textile reinforcing structure (5) combined with an open cell foam layer (4);
injection into the mould of the components (22,23) reacting to produce a resin (24) forming the core (2) and coming into contact with the open cell foam layer (4) of the complex (3);
impregnation of the textile reinforcing structure (5) by injecting a mechanizing resin (31).

11. Method according to claim 10, characterized in that the injection of the mechanizing resin (31) takes place in the mould into which the components forming the resin of the core have been injected.

12. Method according to claim 10, characterized in that the injection of the mechanizing resin (31) takes place in a different mould (30) from the mould (28) in which the core has been formed.

13. Method according to claim 10, characterized in that between the formation of the core and the injection of the mechanizing resin, the mould is opened for placing supplementary layers above the reinforcing structure.

14. Composite part produced by the method according to one of claims 1 to 13, in which the resin of the core (2) partially penetrates into the open cell foam layer (4) of the mechanically reinforcing complex.
